(19) United States
(12) Patent Application Publication
(10) Pub. No.: US 2019/0316691 A1
(43) Pub. Date: Oct. 17, 2019

(54) BYPASS VALVE, EXPANDER UNIT HAVING A BYPASS VALVE, AND WASTE-HEAT RECOVERY SYSTEM HAVING AN EXPANDER UNIT

(71) Applicant: Robert Bosch GmbH, Stuttgart (DE)

(72) Inventor: Nadja Eisenmenger, Stuttgart (DE)

(21) Appl. No.: 16/463,637

(22) PCT Filed: Oct. 4, 2017
(86) PCT No.: PCT/EP2017/075143

§ 371 Date: May 23, 2019

(30) Foreign Application Priority Data
Nov. 24, 2016 (DE) 10 2016 223 275.4

(51) Int. Cl. F16K 11/07; F28D 15/02; F16K 39/02

(52) U.S. Cl. CPC F16K 11/07; F28D 15/0266; F28D 15/06; F28D 2015/0291; F16K 39/024

(57) ABSTRACT

The invention relates to a bypass valve (1), having a valve housing (4) and a slide (3) arranged for longitudinal movement in the valve housing (4). An inlet channel (5), an outlet channel (6), and a further outlet channel (7) are formed in the valve housing (4). The slide (3) interacts with a valve seat (8) formed in the valve housing (4) by means of the longitudinal movement of the slide and thereby opens and closes a hydraulic connection between the inlet channel (5) and the outlet channel (6). Furthermore, the slide (3) interacts with a further valve seat (8b) formed in the valve housing (4) by means of the longitudinal movement of the slide and thereby opens and closes a further hydraulic connection between the inlet channel (5) and the further outlet channel (7). A control surface (3c) is formed on the slide (3), wherein the control surface (3c) delimits a control chamber (34). The pressure in the control chamber can be hydraulically controlled by means of a pilot valve (2).

### BACKGROUND OF THE INVENTION

The invention concerns a bypass valve, an expander unit having a bypass valve, and a waste-heat recovery system having an expander unit. The expander unit and the bypass valve may in particular be used in a waste-heat recovery system of an internal combustion engine.

Expander units with bypass valves are known from the prior art.

A known expander unit comprises an expansion machine, a bypass valve and a bypass line. If required, in this way a working medium can be supplied to the expansion machine or be conducted past this through the bypass line. Such a bypass valve is known for example from application DE 10 2014 224979 A1 (not previously published). The known bypass valve has a valve housing with a slide arranged so as to be longitudinally movable therein. An inlet channel, an outlet channel and a further outlet channel are formed in the valve housing. A closing body of the slide cooperates through its longitudinal movement with a slide seat formed in the valve housing and thereby opens and closes a first hydraulic connection between the inlet channel and the outlet channel. A further closing body of the slide cooperates through its longitudinal movement with a further slide seat formed in the valve housing and thereby opens and closes a second hydraulic connection between the inlet channel and the further outlet channel. The longitudinal movement of the slide is here controlled by an actuator.

A directly actuated slide of a bypass valve requires comparatively high forces for moving the slide longitudinally. The actuator must consequently be designed to be correspondingly large.

### SUMMARY OF THE INVENTION

In comparison, the bypass valve according to the invention comprises a hydraulic actuation of the slide which, in refinements, may also be supported mechanically. In this way, the actuator may be configured so as to be comparatively small since it need only provide low forces.

For this, the bypass valve comprises a valve housing and a slide arranged so as to be longitudinally movable in the valve housing. An inlet channel, an outlet channel, and a further outlet channel are formed in the valve housing. The slide cooperates through its longitudinal movement with a valve seat formed in the valve housing and thereby opens and closes a hydraulic connection between the inlet channel and the outlet channel. The slide furthermore cooperates through its longitudinal movement with a further valve seat formed in the valve housing and thereby opens and closes a further hydraulic connection between the inlet channel and the further outlet channel. A control surface is formed on the slide, wherein the control surface delimits a control chamber. The pressure in the control chamber can be controlled hydraulically by means of a pilot valve.

A hydraulic force acts on the slide via the hydraulic pressure applied to the control surface in the control chamber. This force may be controlled via the pilot valve by reducing or increasing the pressure. The slide then moves accordingly into the control chamber, i.e. reduces its size, or in the opposite direction so that the volume of the control chamber increases. The pilot valve may accordingly be configured so as to be comparatively small since it need merely maintain a maximum pressure in the control chamber or open this against said pressure.

In advantageous embodiments, the control chamber is hydraulically connected to the inlet channel. Preferably, the corresponding hydraulic connection is made via a connecting channel formed in the slide. The inlet channel has a comparatively high pressure in the bypass valve, so this pressure is suitable as a control pressure for the pilot valve. The control surface may therefore be designed so as to be comparatively small.

In advantageous refinements, the pilot valve comprises a valve body and a pilot valve seat. The valve body cooperates with the pilot valve seat and thereby opens and closes a hydraulic pilot connection between the inlet channel and the further outlet channel. Usually, a comparatively low pressure is applied at the further outlet channel of the bypass valve, for example atmospheric pressure or the lower pressure level of a waste-heat recovery system. The maximal hydraulic force which may act on the slide depends on the control surface and the available pressure difference between the inlet channel and the outlet channel. The actuation forces available are therefore proportional to the rising pressure difference and the resulting interference forces which obstruct the movement of the slide. The hydraulic connections of the bypass valve may therefore be rapidly opened and closed with great efficiency.

Advantageously, the pilot valve has an actuator. The actuator controls a movement of the valve body and is preferably an electromagnetic or pneumatic actuator. Thus the pilot valve may be actuated very simply and very quickly via the actuator.

In advantageous refinements, the pilot valve seat is formed on the slide. In this way, the pilot valve is configured so as to be extremely compact. Furthermore, there is no temporal delay in the force acting on the control surface when the pilot valve is opened or closed.

In advantageous refinements, when the pilot valve is closed i.e. when the valve body is pressed against the pilot valve seat, a form-fit connection is formed between the pilot valve seat and the valve body in the direction of a closing movement of the valve body. In this way, the pilot valve can be closed without leakage.

Advantageously, when the pilot valve is closed, the actuator mechanically controls the longitudinal movement of the slide in the direction of the closing movement of the valve body. The slide is thus moved by the form-fit connection in the same direction as the valve body. When the pilot valve is closed, the slide is moved both by the rising hydraulic force on the control surface and by the form-fit connection between the pilot valve seat and the valve body. On further actuation, the actuator therefore exerts a mechanical force on the valve body and consequently, indirectly via the pilot valve seat, also on the slide. This is necessary above all if the hydraulic or fluidic forces are insufficient to move the slide reliably due to a low switching pressure difference at the bypass valve.

In advantageous embodiments, the valve body is formed as a plate, wherein the valve body is formed on a valve needle. The closing movement of the valve body is achieved by a traction load on the valve needle. Consequently, on further actuation when the pilot valve is closed, the actuator exerts a traction force on the slide via the form-fit connection described above.

In alternative advantageous embodiments, the valve body is formed on a valve needle and the closing movement of the valve body is achieved by a pressure load on the valve needle. The valve body may here for example be formed as a ball. Consequently, on further actuation when the pilot valve is closed, the actuator exerts a pressing force on the slide via the form-fit connection described above.

In advantageous refinements, the closing movement of the valve body takes place in the same direction as the longitudinal movement of the slide for closing the further hydraulic connection. In this way, when the pilot valve is closed, both the hydraulic pilot connection and the further hydraulic connection are closed, i.e. both connections between the inlet channel and the further outlet channel. When the pilot valve is opened, accordingly, both connections between the inlet channel and the further outlet channel are opened. In this way, the pilot valve works virtually without leakage, i.e. in the direction of the slide: when the pilot valve is opened, the control quantity of fluid passes from the control chamber into the further outlet channel and hence has the same destination as the remaining fluid flowing through the inlet channel into the bypass valve.

In advantageous refinements, at a maximal opening stroke hpv of the pilot valve, a form-fit connection is formed between the pilot valve and the slide in the direction of an opening movement of the valve body. This further form-fit connection serves as mechanical support for the slide by the pilot valve.

Advantageously, at said maximal opening stroke hpv of the pilot valve, the actuator mechanically controls the longitudinal movement of the slide in the direction of the opening movement of the valve body. The slide is thus moved by the form-fit connection in the same direction as the valve body. When the pilot valve is opened, the movement of the slide is therefore caused by both the diminishing hydraulic force on the control surface and the further form-fit connection between the pilot valve seat and the valve body. On further actuation, the actuator exerts a mechanical force on the valve body and consequently, indirectly via the pilot valve seat, also on the slide.

In advantageous embodiments, the longitudinal movement of the slide is achieved by a pressing movement of the actuator. For this, preferably, an intermediate piece is arranged between the actuator and the slide. In this way, for mechanical support of the longitudinal movement of the slide, the actuator force may easily be transmitted to the slide via the intermediate piece. Ideally, when the pilot valve is closed, a maximal gap is created between the slide and the intermediate piece or between the actuator and the intermediate piece, wherein the size of the gap corresponds to the maximal opening stroke hpv of the pilot valve.

In alternative advantageous embodiments, the longitudinal movement of slide is achieved by a traction movement of the actuator. Preferably, a connecting piece which is connected to the slide, e.g. welded thereto, cooperates with the shoulder of a valve needle of the pilot valve. In this way, for mechanical support of the longitudinal movement of the slide, the actuator force may easily be transmitted to the slide via the connecting piece. Ideally, when the pilot valve is opened, a maximal gap is created between the shoulder of the slide and the connecting piece, wherein the size of the gap corresponds to the maximal opening stroke hpv of the pilot valve.

The connecting piece is preferably formed in the shape of a pot and can guide the valve needle in a longitudinal movement over the opening stroke.

Advantageously, the opening movement of the valve body takes place in the same direction as the longitudinal movement of the slide for opening the further hydraulic connection. In this way, when the pilot valve is opened, the hydraulic connection is closed and the further hydraulic connection opened. Thus both the hydraulic pilot connection and the further hydraulic connection are opened, i.e. both connections between the inlet channel and the further outlet channel. In this way, the pilot valve works virtually without leaks, i.e. in the direction of the slide: when the pilot valve is opened, the control quantity of fluid passes from the control chamber into the further outlet channel and hence has the same destination as the remaining fluid flowing through the inlet channel into the bypass valve.

In advantageous refinements, the bypass valve is arranged in an expander unit. The expander unit comprises an expansion machine, a bypass line and the bypass valve. The bypass line is arranged parallel to the expansion machine, wherein the bypass valve controls the mass flow of working medium to the expansion machine and to the bypass line. The expansion machine is connected to the outlet channel of the bypass valve, and the bypass line is connected to the further outlet channel. The expansion machine serves to convert thermal energy into mechanical energy. In order to operate the expander unit as efficiently as possible, a bypass valve is required which has a very low energy requirement. Therefore the bypass valve according to the invention with the pilot valve is ideally suited as a bypass valve for an expansion machine.

In further advantageous embodiments, the expander unit is arranged in a waste-heat recovery system of an internal combustion engine. The waste-heat recovery system has a circuit carrying a working medium. The circuit comprises, in the flow direction of the working medium, a pump, an evaporator, the expander unit and a condenser.

To achieve a high efficiency of the waste-heat recovery system, it is necessary to convey the working medium to the expansion machine when required or bypass this via the bypass line. The operating states can change very quickly. A robust and rapid actuation of the bypass valve with the lowest possible energy requirement is consequently important for the efficiency of the waste-heat recovery system.

### BRIEF DESCRIPTION OF THE DRAWINGS

FIG. 1 shows diagrammatically a bypass valve in longitudinal section, wherein only the essential regions are depicted.

FIG. 2 shows diagrammatically a further exemplary embodiment of a bypass valve in longitudinal section, wherein only the essential regions are depicted.

FIG. 3 shows diagrammatically a waste-heat recovery system, wherein only the essential regions are depicted.

### DETAILED DESCRIPTION

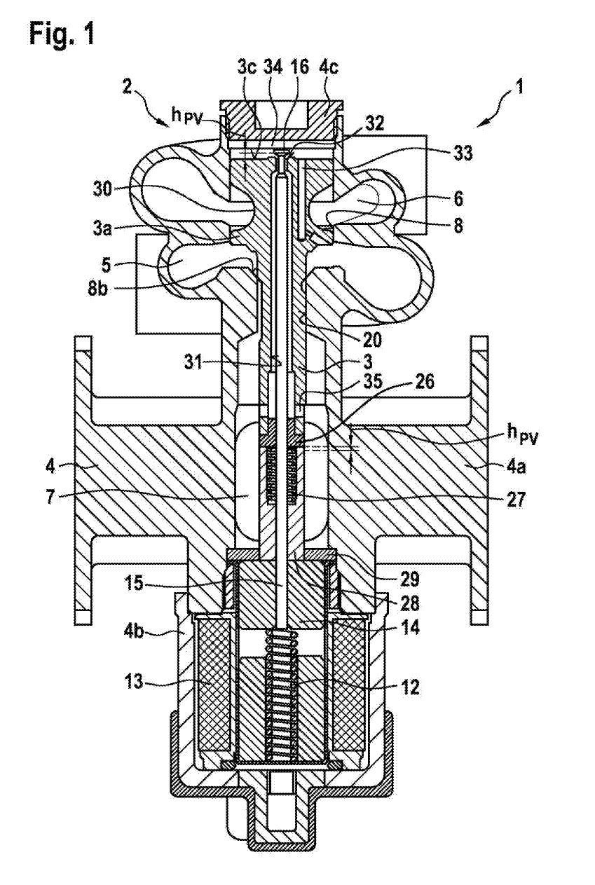

FIG. 1 shows, diagrammatically in longitudinal section, a bypass valve 1 with an electromagnetic actuation of the bypass valve 1, wherein only the essential regions are depicted. In the embodiment in FIG. 1, the bypass valve 1 is configured as an output-controlled bypass valve with a seat valve and a slide valve. In alternative embodiments however, the bypass valve 1 may also be input-controlled, and/or be configured with two seat valves or with two slide valves.

The bypass valve 1 comprises a valve housing 4 with a guide bore 20 formed therein. A slide 3 protrudes through the guide bore 20 and is arranged so as to be longitudinally movable in the valve housing 4. An inlet channel 5, an outlet channel 6 and a further outlet channel 7 are formed in the valve housing 4. Viewed in the axial direction of the bypass valve 1, the inlet channel 5 is arranged between the two outlet channels 6, 7. Alternatively, the inlet channel 5 may also for example be arranged on the end face, i.e. in the axial direction, for example through a bore in the slide 3.

The slide 3 comprises a closing body 3a which cooperates with two valve seats 8, 8b: one valve seat 8 is arranged on the valve housing 4 as a slide seat between the inlet channel 5 and outlet channel 6. A further valve seat 8b is arranged on the valve housing 4 as a conical valve seat between the inlet channel 5 and the further outlet channel 7.

The closing body 3a or the slide 3 cooperates with both the valve seat 8 to open and close a hydraulic connection from the inlet channel 5 to the outlet channel 6, and also with the further valve seat 8b to open and close a further hydraulic connection from the inlet channel 5 to the further outlet channel 7.

A peripheral groove 30 is formed on the slide 3 adjacent to the closing body 3a and constitutes a diameter reduction of the slide 3. When the closing body 3a opens the valve seat 8, the peripheral groove 30 is arranged radially opposite the valve seat 8. The hydraulic connection from the inlet channel 5 to the outlet channel 6 then runs via the peripheral groove 30 and is opened. At the same time, the closing body 3a cooperates with the further valve seat 8b in the opposite sense, in order to open and close the further hydraulic connection from the inlet channel 5 to the further outlet channel 7.

This means that to the extent that the through-flow cross-section through the first hydraulic connection is enlarged by the stroke of the slide 3, the through-flow cross-section through the second hydraulic connection is reduced, and vice versa.

In a first end position of the slide 3, the closing body 3a covers the valve seat 8 and thus closes the hydraulic connection from the inlet channel 5 to the outlet channel 6. In this first end position, the closing body 3a is raised from the further valve seat 8b and thus opens the further hydraulic connection from the inlet channel 5 to the further outlet channel 7.

In a second end position of the slide 3, the closing body 3a is pressed against the further valve seat 8b and thus closes the further hydraulic connection from the inlet channel 5 to the further outlet channel 7. In this second end position, the closing body 3a no longer covers the valve seat 8 and thus opens the hydraulic connection from the inlet channel 5 to the outlet channel 6.

In the middle position of the slide 3, i.e. in the position in which both outlet channels 6, 7 are open, both hydraulic connections may be opened. The bypass valve 1 or the slide 3 may be actuated such that the mass flows in the outlet channel 6 and in the further outlet channel 7 are the same size.

In the exemplary embodiment of FIG. 1, the bypass valve 1 is arranged in a two-part valve housing 4 with a first housing part 4a and a second housing part 4b. The slide 3 is arranged so as to be longitudinally movable substantially in the first housing part 4a. The first housing part 4a is connected media-tightly to the second housing part 4b, for example bolted thereto with the interposition of a gasket. An electromagnetic actuator 13 with a magnetic coil and a magnetic core is arranged stationarily in the second housing part 4b. The actuator 13 is configured so as to be cylindrical and has a bore. An armature 14, configured as a plunger, is arranged in the valve housing 4 so as to be longitudinally movable such that it can protrude into the actuator 13. The armature 14 is pressed away from the actuator 13 by an armature spring 12. The armature spring 12 is arranged in compact fashion substantially in the bore of the actuator 13.

The armature 14 is fixedly connected to a valve needle 15, for example pressed thereon. The valve needle 15 extends through a passage bore 31 formed in the slide 3. At the end opposite the armature 13, the valve needle 15 protrudes out of the slide 3. At this end, the valve needle 15 has a valve body 16. In the embodiment of FIG. 1, the valve body 16 is formed as a plate. The valve body 16 here cooperates with a pilot valve seat 32 formed on the slide 3, and thereby opens and closes a hydraulic pilot connection from the inlet channel 5 to the further outlet channel 7.

The actuator 13, the armature 14, the valve needle 15 with the valve body 16, the pilot valve seat 32, and a control chamber 34 form the pilot valve 2 which controls the longitudinal movement of the slide 3. The pilot valve 2 opens and closes the hydraulic pilot connection.

The hydraulic pilot connection runs from the inlet channel 5 via a connecting channel 33 formed in the slide 3 into the control chamber 34 of the bypass valve 1, and from there via the pilot valve seat 32, the passage bore 31 and radial bores 35 formed in the slide, to the further outlet channel 7. The control chamber 34 is delimited by the slide 3, more precisely by a control surface 3c formed on the end face of the slide 3, by the valve housing 4 and by a housing cover 4c which is bolted media-tightly to the valve housing. The control surface 3c is here formed so as to surround the pilot valve seat 32.

The hydraulically acting pressure in the control chamber 34 acts on the control surface 3c in the direction of the actuator 13, i.e. against the force of the armature spring 12.

When the actuator 13 is powered, it pulls the armature 14 against the spring force of the armature spring 12 so that the armature 14 is drawn almost into the actuator 13. In this way, the valve body 16 is also drawn against the pilot valve seat 32 and the hydraulic pilot connection is closed. So in operation of the bypass valve 1, fluid flows from the inlet channel 5 via the connecting channel 33 into the control chamber 34, and the pressure in the control chamber 34 rises. As long as the slide 3 does not move again, the pressure in the control chamber 3c rises accordingly until the resulting hydraulic or fluidic forces on the control surface 3c are sufficiently large and set the slide 3 in motion in the direction of the actuator 13. As soon as the closing body 3a is pressed against the further valve seat 8b, the pressure in the control chamber 3c rises further until it corresponds to the pressure of the inlet channel 5. The further hydraulic connection is closed and the hydraulic connection from the inlet channel 5 to the outlet channel 6 is opened. Consequently, fluid can flow from the inlet channel 5 to the outlet channel 6. Both the further hydraulic connection and the hydraulic pilot connection in the further outlet channel 7 are blocked. This process of closing the further hydraulic connection takes place comparatively slowly and gently so as to minimize wear on the further valve seat 8b.

When the actuator 13 is no longer powered, the armature spring 12 presses the armature 14 away from the actuator 13, i.e. upward in the depiction in FIG. 1, against a stop ring 29 fixed in the valve housing 4. In this way, the valve body 16 lifts away from the pilot valve seat 32 and the hydraulic pilot connection is opened. The pressure of the further outlet channel 7, i.e. a pressure lower than that of the inlet channel 5, is set in the control chamber 34. The resulting hydraulic force on the control surface 3c is reduced thereby, so that the slide 3 or closing body 3a is raised away from the further valve seat 8b by the armature spring 12, and at the same time the closing body 3a is pushed into the valve seat 8. The hydraulic connection is closed and the further hydraulic connection from the inlet channel 5 to the further outlet channel 7 is opened. Accordingly, fluid can flow from the inlet channel 5 to the further outlet channel 7, firstly through the hydraulic connection and secondly through the hydraulic pilot connection.

In an advantageous embodiment, the bypass valve 1 shown in FIG. 1 comprises a guide sleeve 26, a slide spring 27 and an intermediate piece 28. The guide sleeve 26 is pushed at least partially into the passage bore 31 of the slide 3, for example pressed therein. A bore is also formed in the guide sleeve 26, and the valve needle 15 is guided so as to be longitudinally movable therein.

The slide spring 27 at one end cooperates with the guide sleeve 26 and at the other end with the intermediate piece 28, i.e. it presses the two pieces apart. The slide spring 27 thus firstly presses the intermediate piece 28 against the armature 14 and secondly presses the slide 3 against the valve needle 15.

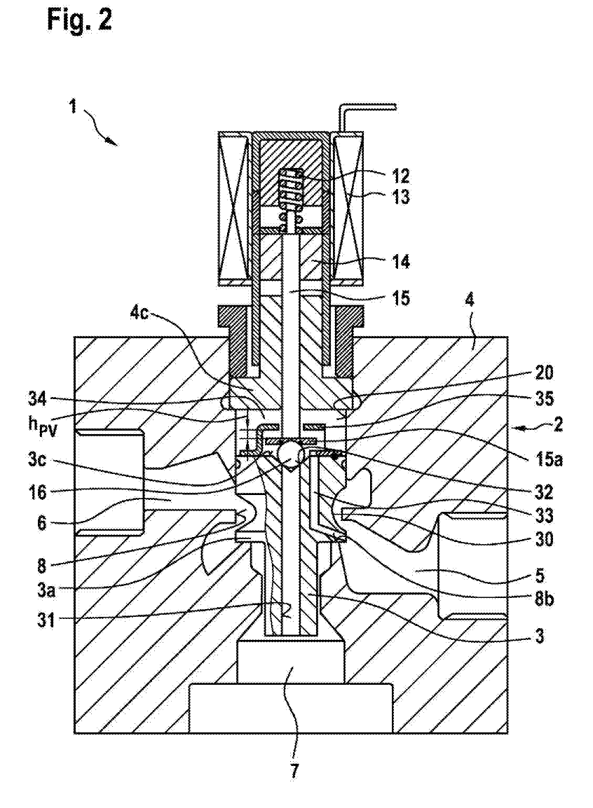

FIG. 2 shows, in longitudinal section, a further exemplary embodiment of the bypass valve 1 according to the invention, wherein only the essential regions are depicted. The slide 3 is arranged so as to be longitudinally movable in the guide bore 20 of the valve housing 4. The closing body 3a of the slide 3 cooperates firstly with the valve seat 8, formed as a slide seat, for opening and closing the hydraulic connection from the inlet channel 5 to the outlet channel 6. Secondly, the closing body 3a cooperates with the further valve seat 8b, formed as a flat seat, for opening and closing the further hydraulic connection from the inlet channel 5 to the further outlet channel 7.

In the embodiment of FIG. 2, the pilot valve 2 comprises a spherical valve body 16. The valve body 16 cooperates with the pilot valve seat 32 formed on the slide 3 to open and close the hydraulic pilot connection from the inlet channel 5, via the connecting channel 33, control chamber 34 and passage bore 31, to the further outlet channel 7.

In the embodiment of FIG. 2, the valve needle 15 is guided through the housing cover 4c. The guide between the bore in the housing cover 4c and the valve needle 15 is preferably formed with little play and low leakage. At its end opposite the control chamber 34, the valve needle 15 is fixedly connected to the armature 14, for example it may also be formed integrally therewith. The armature 14 may itself be actuated by the actuator 13, for example electromagnetically, so that when the actuator 13 is powered, the armature 14 moves away from the pilot valve seat 32. The armature spring 12 again presses the armature 14, and with it the valve needle 15 and closing body 16, against the pilot valve seat 32 i.e. against the slide 3.

In a refinement of the invention as shown in FIG. 2, the pilot valve 2 may comprise a connecting piece 35 which is arranged so as to surround the valve body 16. The connecting piece 35 may be fixedly connected to the slide 3, for example welded thereto, and thus forms a stop for a shoulder 15a of the valve needle 15 in order thereby to set a maximal distance between the valve needle 15 or valve body 16 on one side and the pilot valve seat 32 on the other, i.e. a maximal opening stroke hpv of the pilot valve 2. By means of the connecting piece 35, the stroke of the valve body 16, i.e. the maximal opening stroke hpv, can be set.

In the embodiment of FIG. 2, the connecting piece 35 is formed as a pot and welded to the slide 3 in the region of the pot opening. The pot base of the connecting piece 35 has an opening through which the valve needle 15 protrudes. The valve needle 15 may therefore be guided by the connecting piece 35 in a longitudinal movement over the opening stroke. The shoulder 15a is arranged inside the pot-like connecting piece 35 and cooperates with the pot base in order to achieve a mechanical form-fit connection between the pilot valve 2 and the slide 3, as will be explained in more detail below.

In the embodiment of FIG. 2, the bypass valve 1 and the pilot valve 2 function such that when not powered, the closing body 3a is pressed indirectly by the armature spring 12 against the further valve seat 8b; thus when the actuator 13 is not powered, the hydraulic connection between the inlet channel 5 and the outlet channel 6 is opened and the further hydraulic connection from the inlet channel 5 to the further outlet channel 7 is closed.

When the actuator 13 is powered, this pulls the armature 14 against the spring force of the armature spring 12 so that the armature 14 is drawn almost into the actuator 13. The valve body 16 is thereby lifted away from the pilot valve seat 32 and the hydraulic pilot connection is opened. Thus the pressure of the further outlet channel 7 is set in the control chamber 34, i.e. a comparatively low pressure. Because of the resulting changing hydraulic force on the slide 3, the latter is pressed in the direction of the actuator 13 so that the closing body 3a is lifted away from the further valve seat 8b and at the same time pushed into the valve seat 8. The further hydraulic connection from the inlet channel 5 to the further outlet channel 7 is opened, and the hydraulic connection from the inlet channel 5 to the outlet channel 6 is closed. Accordingly, fluid can flow from the inlet channel 5 to the further outlet channel 7.

When the actuator 13 is no longer powered, the armature spring 12 presses the armature 14, and with it the valve needle 15 and valve body 16, into the pilot valve seat 32. The hydraulic pilot connection is thereby closed, and the pressure of the inlet channel 5 is set in the control chamber 34, i.e. a comparatively high pressure. This also acts on the control surface 3c of the slide 3 and presses this against the further valve seat 8b. The hydraulic connection from the inlet channel 5 to the outlet channel 6 is opened, and the further hydraulic connection from the inlet channel 5 to the further outlet channel 7 is closed. Accordingly, the fluid can flow from the inlet channel 5 to the outlet channel 6.

In preferred refinements of the invention for both the embodiment according to FIG. 1 and that according to FIG. 2, the pilot valve 2 controls the movement of the slide 3 not only hydraulically but also mechanically:

In the embodiment according to FIG. 1, when the actuator 13 is powered, the valve needle 15 pulls the slide 3 mechanically in the direction of the further valve seat 8b by the form-fit connection between the valve body 16 and the pilot valve seat 32. The valve needle 15 thus also mechanically supports the opening of the hydraulic connection and at the same time the closing of the further hydraulic connection. In an advantageous refinement, the pilot valve 2 also supports the movement of the slide 3 in the opposite direction: when the actuator 13 is no longer powered, the armature spring 12 presses the armature 14 against the slide 3, with the interposition of the intermediate piece 28 and guide sleeve 26, after overcoming the maximal opening stroke hpv of the pilot valve 2. On the further stroke of the valve needle 16, the slide 3 is thus also mechanically pushed away from the further valve seat 8b by the pilot valve 2. The pilot valve 2 thereby also mechanically supports the closing of the hydraulic connection and simultaneously the opening of the further hydraulic connection.

In the embodiment according to FIG. 2, when the actuator 13 is powered, after exceeding the maximal opening stroke hpv of the pilot valve 2, the valve needle 15 pulls the connecting piece 35 away from the valve seat 8b via the form-fit connection between the connecting piece 35 and the shoulder 15a of the valve needle 15 and, together with the connecting piece 35, also the slide 3 connected thereto. In this way, the valve needle 15 also mechanically supports the closing of the hydraulic connection and simultaneously the opening of the further hydraulic connection. Furthermore, the pilot valve 2 also supports the movement of the slide 3 in the opposite direction: when the actuator 13 is no longer powered, after overcoming the maximal opening stroke h_{PV} of the pilot valve 2, the armature spring 12 presses the armature 14, and with it the valve needle 15 and valve body 16, against the pilot valve seat 32 and hence against the slide 3. On the further stroke of the valve needle 15, the slide 3 is therefore also pressed mechanically against the further valve seat 8b by the pilot valve 2. The pilot valve 2 thereby also mechanically supports the closing of the further hydraulic connection and simultaneously the opening of the hydraulic connection.

The two embodiments shown in FIG. 1 and FIG. 2 share the feature that, on closing of the hydraulic pilot connection, the further hydraulic connection from the inlet channel 5 to the further outlet channel 7 is also closed. Thus the pilot valve 2 works virtually without leaks. The closing movement is here supported by the pressure in the control chamber 34. On opening of the hydraulic pilot connection, the further hydraulic connection from the inlet channel 5 to the further outlet channel 7 is also opened. In this position of the bypass valve 1, there are two hydraulic connections from the inlet channel 5 to the further outlet channel 7: via the further hydraulic connection and via the hydraulic pilot connection.

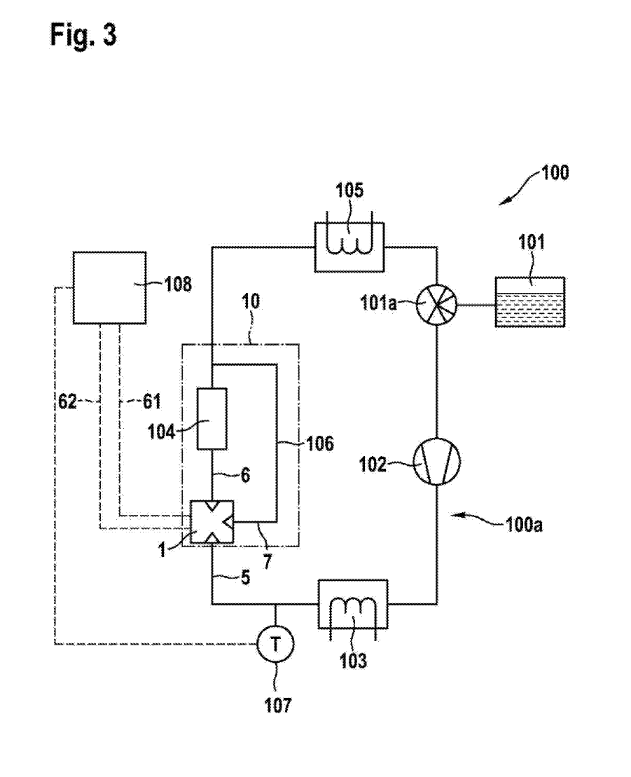

FIG. 3 shows diagrammatically a waste-heat recovery system 100 of an internal combustion engine (not shown), wherein only the essential regions are depicted.

The waste-heat recovery system 100 has a circuit 100a conducting a working medium, which in the flow direction of the working medium comprises a feed fluid pump 102, an evaporator 103, an expander unit 10 and a condenser 105. The expander unit 10 comprises the bypass valve 1 according to the invention and a parallel circuit of an expansion machine 104 and a bypass channel 106. The working medium may as required also be fed into the circuit 100a from a collection tank 101 via a stub line and a valve arrangement 101a. The collection tank 101 may alternatively also be integrated in the circuit 100a.

The evaporator 103 is connected to an exhaust gas line of the internal combustion engine, so that it utilizes the thermal energy of the exhaust gas of the internal combustion engine.

The bypass line 106 is arranged parallel to the expansion machine 104. Depending on the operating state of the internal combustion engine and the resulting values, for example temperatures of the working medium, the working medium is supplied to the expansion machine 104 or conducted past the expansion machine 104 through the bypass line 106. For example, a temperature sensor 107 is arranged downstream of the evaporator 103. The temperature sensor 107 determines the temperature of the working medium after the evaporator 103 or establishes corresponding signals and transmits these to a control unit 108. The control unit 108 activates the actuator 13 of the bypass valve 1 via the two electrical lines 61, 62 depending on various data, such as for example the temperature of the working medium after the evaporator 103.

The bypass valve 1 is connected such that the working medium is conducted either into the expansion machine 104 through the hydraulic connection via the outlet channel 6, or into the bypass line 106 through the further hydraulic connection via the further outlet channel 7. The further outlet channel 7 accordingly corresponds at least partially to the bypass line 106. In other words, when the pilot valve 2 is opened, the quantity of working medium discharged from the control chamber 34 flows into the bypass line 106 both via the further hydraulic connection and via the hydraulic pilot connection, and therefore has the same destination. The quantity of working medium diverted through the pilot valve 2 is not therefore lost.

The mass flow of the working medium may also be divided such that part of the working medium is supplied to the expansion machine 104 and a further part to the bypass line 106. The operating states of the waste-heat recovery system 100 may change very quickly, so that the bypass valve 1 must be switched quickly and also as energy-savingly as possible with no loss quantities. The bypass valve 1 according to the invention fulfils these requirements perfectly.

1. A bypass valve (1) comprising a valve housing (4) and a slide (3) longitudinally movable in the valve housing (4), wherein an inlet channel (5), an outlet channel (6) and a further outlet channel (7) are formed in the valve housing (4), wherein the slide (3) cooperates through longitudinal movement with a valve seat (8) formed in the valve housing (4) and thereby opens and closes a hydraulic connection between the inlet channel (5) and the outlet channel (6), wherein the slide (3) furthermore cooperates through longitudinal movement with a further valve seat (8b) formed in the valve housing (4) and thereby opens and closes a further hydraulic connection between the inlet channel (5) and the further outlet channel (7), wherein a control surface (3c) is formed on the slide (3), wherein the control surface (3c) delimits a control chamber (34), and wherein the bypass valve further comprises a pilot valve (2) for hydraulically controlling the pressure in the control chamber.

2. The bypass valve (1) as claimed in claim 1, characterized in that the control chamber (34) is hydraulically connected to the inlet channel (5).

3. The bypass valve (1) as claimed in claim 1, characterized in that the pilot valve (2) comprises a valve body (16) and a pilot valve seat (32), wherein the valve body (16) cooperates with the pilot valve seat (32) and thereby opens and closes a hydraulic pilot connection between the inlet channel (5) and the further outlet channel (7).

4. The bypass valve (1) as claimed in claim 3, characterized in that the pilot valve (2) has an actuator (13), wherein the actuator (13) controls a movement of the valve body (16).

5. The bypass valve (1) as claimed in claim 4, characterized in that the pilot valve seat (32) is formed on the slide (3).

6. The bypass valve (1) as claimed in claim 5, characterized in that when the pilot valve (2) is closed, a form-fit connection is formed between the pilot valve seat (32) and the valve body (16) in a direction of a closing movement of the valve body (16).

7. The bypass valve (1) as claimed in claim 6, characterized in that when the pilot valve (2) is closed, the actuator (13) mechanically controls the longitudinal movement of the slide (3) in the direction of the closing movement of the valve body (16).

8. The bypass valve (1) as claimed in claim 7, characterized in that the valve body (16) is formed as a plate, wherein the valve body (16) is formed on a valve needle (15), wherein the closing movement of the valve body (16) is achieved by a traction load on the valve needle (15).

9. The bypass valve (1) as claimed in claim 7, characterized in that the valve body (16) is formed on a valve needle (15), wherein the closing movement of the valve body (16) is achieved by a pressure load on the valve needle (15).

10. The bypass valve (1) as claimed in claim 7, characterized in that the closing movement of the valve body (16) takes place in the same direction as the longitudinal movement of the slide (3) for closing the further hydraulic connection.

11. The bypass valve (1) as claimed in claim 4, characterized in that at a maximal opening stroke (h_{PV}) of the pilot valve (2), a form-fit connection is formed between the pilot valve (2) and the slide (3) in a direction of an opening movement of the valve body (16).

12. The bypass valve (1) as claimed in claim 11, characterized in that at the maximal opening stroke (h_{PV}) of the pilot valve (2), the actuator (13) mechanically controls the longitudinal movement of the slide (3) in the direction of the opening movement of the valve body (16).

13. The bypass valve (1) as claimed in claim 12, characterized in that the longitudinal movement of the slide (3) is achieved by a pressing movement of the actuator (13).

14. The bypass valve (1) as claimed in claim 12, characterized in that the longitudinal movement of slide (3) is achieved by a traction movement of the actuator (13).

15. The bypass valve (1) as claimed in claim 11, characterized in that the opening movement of the valve body (16) takes place in the same direction as the longitudinal movement of the slide (3) for opening the further hydraulic connection.

16. An expander unit (10) comprising a bypass valve (1) as claimed in claim 1, an expansion machine (104), and a bypass line (106), wherein the bypass line (106) is arranged parallel to the expansion machine (104), wherein the bypass valve (1) controls a mass flow of working medium to the expansion machine (104) and to the bypass line (106), wherein the bypass line (106) is hydraulically connected to the further outlet channel (7), and wherein the expansion machine (104) is hydraulically connected to the outlet channel (6).

17. A waste-heat recovery system (100) with a circuit (100a) carrying a working medium and including an expander unit (10) as claimed in claim 16, wherein the circuit (100a) comprises, in a flow direction of the working medium, a pump (102), an evaporator (103), the expander unit (10), and a condenser (105), wherein the evaporator (103) is hydraulically connected to the inlet channel (5).

18. The bypass valve (1) as claimed in claim 1, characterized in that the control chamber (34) is hydraulically connected to the inlet channel (5) via a connecting channel (33) formed in the slide (3).

19. The bypass valve (1) as claimed in claim 12, characterized in that the longitudinal movement of the slide (3) is achieved by a pressing movement of the actuator (13), wherein an intermediate piece (28) is arranged between the actuator (13) and the slide (3).

20. The bypass valve (1) as claimed in claim 12, characterized in that the longitudinal movement of slide (3) is achieved by a traction movement of the actuator (13), wherein a connecting piece (35) connected to the slide (3) cooperates with a shoulder (15a) of a valve needle (15) of the pilot valve (2).
